(19) United States
(12) Patent Application Publication
(10) Pub. No.: US 2026/0112652 A1
(43) Pub. Date: Apr. 23, 2026

(54) CURRENT COLLECTOR AND BATTERY

(71) Applicant: TOYOTA JIDOSHA KABUSHIKI KAISHA, Toyota-shi (JP)

(72) Inventors: Masayoshi HAGA, Nagoya-shi (JP); Ryuto SAKAMOTO, Okazaki-shi (JP); Masaki FURUKAWA, Toyota-shi (JP); Tetsuya MIMURA, Chiryu-shi (JP); Atsushi SUGIHARA, Toyota-shi (JP); Satoshi MORIYAMA, Nagoya-shi (JP); Keita YAMASHITA, Nagoya-shi (JP); Hideyuki NAGAI, Nagoya-shi (JP)

(73) Assignee: TOYOTA JIDOSHA KABUSHIKI KAISHA, Toyota-shi (JP)

(21) Appl. No.: 19/248,737

(22) Filed: Jun. 25, 2025

(30) Foreign Application Priority Data
Oct. 17, 2024 (JP) 2024-181840

(51) Int. Cl. H01M 4/66

(52) U.S. Cl. CPC H01M 4/667; H01M 4/661; H01M 4/668

(57) ABSTRACT

A current collector includes a support layer and a first conductive layer. The first conductive layer is made of a metal. The first conductive layer is laminated on the support layer. The support layer contains acid-modified polyethylene terephthalate. According to the present disclosure, it is possible to increase the rigidity of the support layer while suppressing separation of the conductive layer from the support layer.

### CROSS-REFERENCE TO RELATED APPLICATION

This application claims priority to Japanese Patent Application No. 2024-181840 filed on Oct. 17, 2024. The disclosure of the above-identified application, including the specification, drawings, and claims, is incorporated by reference herein in its entirety.

### BACKGROUND

### 1. Technical Field

The present disclosure relates to a current collector and a battery.

### 2. Description of Related Art

Japanese Unexamined Patent Application Publication (Translation of PCT Application) No. 2024-510696 (JP 2024-510696 A) discloses a conventional electrode plate. The electrode plate includes a current collector, an active material layer, and an electrical connection member. The current collector includes a support layer and a conductive layer. The support layer is a polyethylene film, a polypropylene film, a polyvinylidene chloride film, or a multilayer composite film thereof. The conductive layer is disposed on one surface of the support layer. When the current collector is a cathode current collector, aluminum is usually used as the material of the conductive layer, and when the current collector is an anode current collector, copper is usually used as the material of the conductive layer.

### SUMMARY

There is a demand to further reduce the weight of a current collector by making a conductive layer thinner. This is because by reducing the weight of the current collector, the energy density per unit weight of a battery can be increased. On the other hand, making the conductive layer thinner reduces the overall rigidity of the current collector. For this reason, there is a demand for increasing the rigidity of a support layer made of resin.

However, when the rigidity of the resin material constituting the support layer is too high, bending of the current collector may cause fine cracks in the support layer, or bending of the support layer. The conductive layer easily separates from the cracked portion or the bent portion of the support layer.

The present disclosure has been made in consideration of the above problems, and aims to provide a current collector and a battery that can increase the rigidity of a support layer while suppressing separation of the support layer from a conductive layer.

A current collector according to an aspect of the present disclosure includes a support layer and a first conductive layer. The first conductive layer is made of a metal. The first conductive layer is laminated on the support layer. The support layer contains acid-modified polyethylene terephthalate.

A battery according to an aspect of the present disclosure includes an electrode body and an external terminal. The electrode body includes a first electrode, a second electrode, and a separator. The first electrode includes a current collector and an active material layer. The current collector includes a support layer and a conductive layer. The conductive layer is made of a metal. The conductive layer is laminated on the support layer. The support layer contains acid-modified polyethylene terephthalate. The active material layer is laminated on the conductive layer. The separator is laminated on the active material layer. The second electrode is laminated on the active material layer via the separator. The external terminal is electrically connected to the conductive layer.

According to the present disclosure, it is possible to increase the rigidity of the support layer while suppressing separation of the conductive layer from the support layer.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional view illustrating a battery according to an embodiment;

FIG. 2 is a cross-sectional view of an electrode body in FIG. 1, taken along line II-II;

FIG. 3 is a deployed view of a first electrode according to the embodiment; and

FIG. 4 is a partial sectional view of the first electrode in FIG. 3, taken along line IV-IV.

### DETAILED DESCRIPTION OF EMBODIMENTS

Hereinafter, a current collector and a battery according to an embodiment of the present disclosure will be described with reference to the drawings. The same reference signs are given to the same or equivalent portions in the drawings, and the description of such portions will not be repeated.

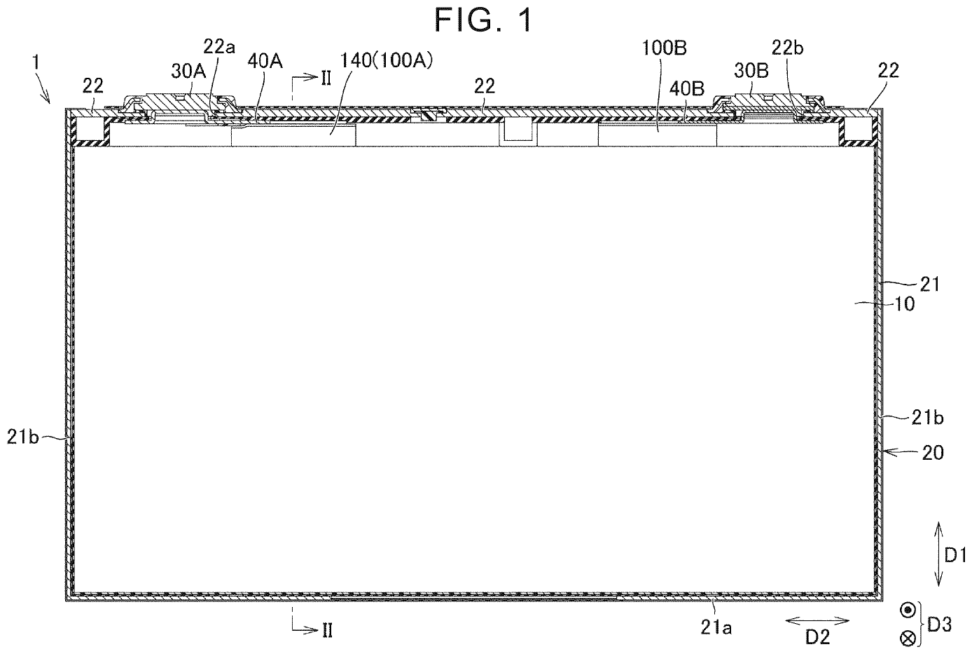

FIG. 1 is a sectional view illustrating the battery according to the embodiment. A battery 1 shown in FIG. 1 is a so-called prismatic battery. The battery 1 may be a secondary battery configured to be capable of charging and discharging, such as a lithium ion battery, and a nickel metal hydride battery. The battery 1 can be used, for example, as a cell included in a power storage module mounted on an electrified vehicle.

As shown in FIG. 1, the battery 1 according to the embodiment of the present disclosure includes an electrode body 10, a case 20, a first external terminal 30A, a second external terminal 30B, a first connecting member 40A, and a second connecting member 40B. First, configurations of components of the battery 1 other than the electrode body 10 will be described.

The case 20 is conductive. A conductive portion of the case 20 is made of a metal, such as aluminum. The case 20 houses the electrode body 10. The case 20 also houses an electrolyte (not shown).

The case 20 includes a case body 21 and a lid 22. The case body 21 includes a bottom wall 21a and a peripheral wall 21b standing upright from the bottom wall 21a.

The lid 22 is joined to the peripheral wall 21b, such as by welding, so as to close an opening of the peripheral wall 21b. The lid 22 has a first connecting hole 22a and a second connecting hole 22b.

The first external terminal 30A and the second external terminal 30B are provided in the battery 1 so as to be exposed to the outside. The first connecting member 40A and the second connecting member 40B are conductive. At least a portion of the first connecting member 40A and at least a portion of the second connecting member 40B are disposed inside the case 20.

The first external terminal 30A or the first connecting member 40A is inserted into the first connecting hole 22a. The first external terminal 30A is electrically connected to the first connecting member 40A. Specifically, the first external terminal 30A and the first connecting member 40A are joined to each other. The first connecting member 40A is joined to the electrode body 10. Accordingly, the first external terminal 30A is electrically connected to the electrode body 10.

The second external terminal 30B or the second connecting member 40B is inserted into the second connecting hole 22b. The second external terminal 30B is electrically connected to the second connecting member 40B. Specifically, the second external terminal 30B and the second connecting member 40B are joined to each other. The second connecting member 40B is joined to the electrode body 10. Accordingly, the second external terminal 30B is electrically connected to the electrode body 10.

In the embodiment, the first external terminal 30A is a cathode terminal, and the second external terminal 30B is an anode terminal. The first external terminal 30A and the second external terminal 30B are arranged in a second direction D2. The second direction D2 is a direction orthogonal to a first direction D1.

Next, the electrode body 10 will be described. The battery 1 according to the embodiment includes a plurality of the electrode bodies 10. The battery 1 typically includes two electrode bodies 10. These electrode bodies 10 are arranged in a third direction D3. The third direction D3 is a direction orthogonal to both the first direction D1 and the second direction D2.

In the following, one of the electrode bodies 10 will be described. Each of the electrode bodies 10 may have the configuration shown below.

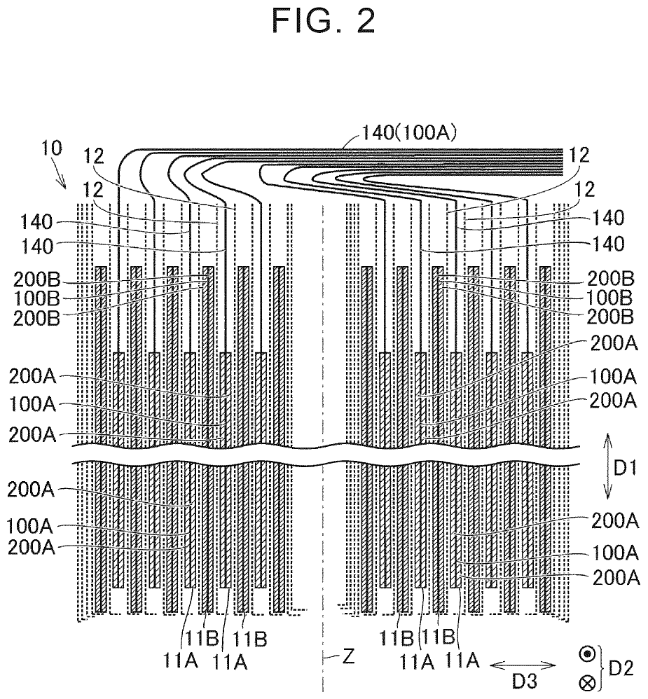

FIG. 2 is a cross-sectional view of the electrode body in FIG. 1, taken along line II-II. As shown in FIGS. 1 and 2, the electrode body 10 includes a first electrode 11A, a second electrode 11B, and separators 12. In the electrode body 10, the first electrode 11A, the second electrode 11B, and the separators 12 are wound around to surround a winding axis Z. Thus, in the embodiment, the electrode body 10 is a so-called wound electrode body. However, the electrode body 10 may be a stacked electrode body in which the first electrodes 11A, the second electrodes 11B, and the separators 12 are stacked in one direction (for example, the third direction D3). In FIG. 2, the separators 12 are schematically represented by dashed lines.

The first electrode 11A and the second electrode 11B have a sheet-like outer shape. The electrode body 10 includes an electrode plate group in which the first electrode 11A and the second electrode 11B are wound with one or more separators 12 interposed therebetween. In the embodiment, the first electrode 11A is a cathode, and the second electrode 11B is an anode. However, the first electrode 11A may be an anode and the second electrode 11B may be a cathode.

The separators 12 are provided between the first electrode 11A and the second electrode 11B. The separators 12 separate the first electrode 11A from the second electrode 11B while allowing ions to travel between the first electrode 11A and the second electrode 11B. The ions are, for example, lithium ions. The separators 12 have electrical insulation properties.

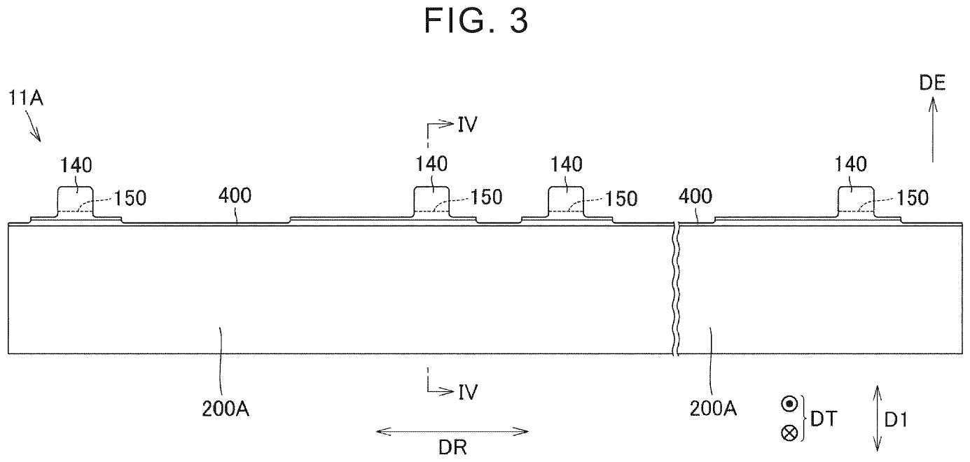

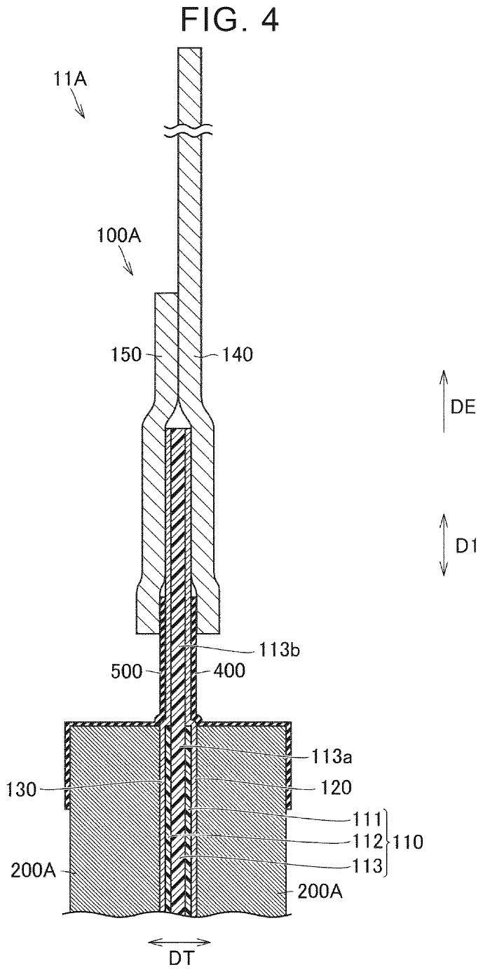

FIG. 3 is a deployed view of the first electrode 11A according to the embodiment. That is, FIG. 3 shows the state before the first electrode 11A is wound. FIG. 4 is a partial sectional view of the first electrode 11A in FIG. 3, taken along line IV-IV.

As shown in FIGS. 2 to 4, the first electrode 11A includes a first current collector 100A, a pair of first active material layers 200A, a first protective portion 400, and a second protective portion 500.

The first current collector 100A includes a support layer 110, a first conductive layer 120, a second conductive layer 130, a plurality of tab portions 140, and a plurality of conductive auxiliary portions 150.

The support layer 110 is made of an electrically insulating resin composition. Therefore, the first current collector 100A is a composite current collector made up of a conductive member and an electrically insulating member. This makes the first current collector 100A lighter than when the first current collector 100A is made entirely of metal, and this also improves the safety of the battery 1 as a whole.

The support layer 110 contains acid-modified polyethylene terephthalate (hereinafter, sometimes referred to as “acid-modified PET”). The acid-modified PET is typically a dicarboxylic acid-modified PET. That is, in the embodiment, the acid-modified polyethylene terephthalate is a copolymer of polyester resins obtained by condensation polymerization of a dicarboxylic acid component and a diol component. In the polyester resins, the dicarboxylic acid component has terephthalic acid as a first main component and another dicarboxylic acid as a second main component, and the diol component has ethylene glycol as a main component. When the dicarboxylic acid included in the acid-modified polyethylene terephthalate has the other dicarboxylic acid, the main chain becomes shorter and crystallization is suppressed compared to polyethylene terephthalate (hereinafter sometimes referred to as “PET”) in which the dicarboxylic acid has only terephthalic acid. This makes the support layer 110 less susceptible to cracking or bending. The support layer 110 may contain a resin other than the acid-modified PET, and various additives.

Examples of the other dicarboxylic acids include phthalic acid, isophthalic acid, maleic acid, 2,6-naphthalenedicarboxylic acid, adipic acid, and sebacic acid. The other dicarboxylic acid is preferably isophthalic acid. The diol component included in the acid-modified polyethylene terephthalate includes ethylene glycol, and may further include, in addition to ethylene glycol, 1,3-propanediol, 1,4-butanediol, 1,4-cyclohexanedimethanol, bisphenol, and the like.

A thickness direction DT of the support layer 110 is substantially orthogonal to the first direction D1. That is, the support layer 110 extends in a direction substantially orthogonal to the first direction D1.

In order to reduce the overall thickness of the electrode body 10, the overall thickness of the support layer 110 is, for example, preferably 20 μm or less, more preferably 15 μm or less, and even more preferably 10 μm or less. The overall thickness of the support layer 110 is not particularly limited as long as it has a desired rigidity. The thickness of the support layer 110 may be, for example, 2 μm or more.

The support layer 110 includes a first portion 111, a second portion 112, and a third portion 113. The first portion 111 includes a surface of the support layer 110 on one side thereof in the thickness direction DT. The first portion 111 includes a part of the surface of the support layer 110 on one side thereof. The first portion 111 may include the entire surface of the support layer 110 on one side thereof.

The second portion 112 includes a surface of the support layer 110 on the other side thereof in the thickness direction DT. The second portion 112 includes a part of the surface of the support layer 110 on the other side thereof. The second portion 112 may include the entire surface of the support layer 110 on the other side thereof.

The third portion 113 is located between the first portion 111 and the second portion 112 in the thickness direction DT. The third portion 113 includes a middle portion 113a and an extension portion 113b. The middle portion 113a is a portion of the third portion 113, and is located between the first portion 111 and the second portion 112. The extension portion 113b extends outward from the middle portion 113a between the first portion 111 and the second portion 112. The entire third portion 113 may be located between the first portion 111 and the second portion 112.

The first portion 111 contains acid-modified PET. The second portion 112 contains acid-modified PET. The acid-modified PET contained in the second portion 112 may be the same as or different from the acid-modified PET contained in the first portion 111. The acid-modified PET that may be included in the first portion 111 and the second portion 112 includes the acid-modified PET that may be contained in the support layer 110 described above. The third portion 113 contains a PET resin. A typical example of a PET resin that may be contained in the third portion 113 is polyethylene terephthalate (PET) that uses terephthalic acid as the dicarboxylic acid component and ethylene glycol as the diol component. The third portion 113 does not contain acid-modified PET.

The first conductive layer 120 is laminated on the support layer 110. The first conductive layer 120 is in contact with the first portion 111. The first conductive layer 120 is laminated over the entire first portion 111. The first conductive layer 120 is also laminated on the extension portion 113b of the third portion 113. A portion of the first conductive layer 120 that is laminated on the extension portion 113b is covered with the tab portion 140 or the first protective portion 400. Therefore, separation of the first conductive layer 120 on the extension portion 113b is suppressed by the tab portion 140 or the first protective portion 400.

The second conductive layer 130 is laminated on the support layer 110 on the opposite side of the support layer 110 from the first conductive layer 120. The second conductive layer 130 is in contact with the second portion 112. The second conductive layer 130 is laminated over the entire second portion 112. The second conductive layer 130 is also laminated on the extension portion 113b of the third portion 113. A portion of the second conductive layer 130 that is laminated on the extension portion 113b is covered with the conductive auxiliary portion 150 or the second protective portion 500. Therefore, separation of the second conductive layer 130 on the extension portion 113b is suppressed by the conductive auxiliary portion 150 or the second protective portion 500.

The first conductive layer 120 and the second conductive layer 130 are made of a metal. The metal includes aluminum, copper, nickel, stainless steel, and the like. The first conductive layer 120 and the second conductive layer 130 are typically made of a metal including aluminum. Accordingly, the first current collector 100A including the first conductive layer 120 and the second conductive layer 130 can be suitably used as a cathode current collector. The first current collector 100A may be an anode current collector, and the first conductive layer 120 and the second conductive layer 130 may be made of a metal including copper.

The thickness of the first conductive layer 120 and the thickness of the second conductive layer 130 are less than the thickness of the support layer 110. In order to reduce the overall thickness of the electrode body 10, the thickness of the first conductive layer 120 and the thickness of the second conductive layer 130 is, for example, 5 μm or less, more preferably 2 μm or less, and even more preferably 1 μm or less. The thickness of the first conductive layer 120 and the thickness of the second conductive layer 130 may be, for example, 0.1 μm or more in order to restrain the electrical resistance of the first conductive layer 120 and the second conductive layer 130 from becoming too large. In addition, when the thickness of the first conductive layer 120 and the thickness of the second conductive layer 130 are 5 μm or less, it is difficult to directly weld the first conductive layer 120 and the second conductive layer 130 to each other or to directly join them to each other by ultrasonic welding.

The method of forming the first conductive layer 120 and the second conductive layer 130 is not particularly limited. Typically, the first conductive layer 120 and the second conductive layer 130 may be provided on the support layer 110 by a deposition method, a sputtering method, or the like. The first conductive layer 120 and the second conductive layer 130 may be made of a metal film. In this case, the first conductive layer 120 and the second conductive layer 130 may be bonded to the support layer 110 via a resin adhesive.

As shown in FIG. 3, the tab portions 140 are arranged in a winding direction DR of the electrode body 10. The conductive auxiliary portions 150 are arranged in the winding direction DR of the electrode body 10. The tab portions 140 are spaced apart from each other. The conductive auxiliary portions 150 are spaced apart from each other. The conductive auxiliary portions 150 are arranged in a one-to-one correspondence between the tab portions 140 and the conductive auxiliary portions 150 in the thickness direction DT.

As shown in FIG. 2, the tab portions 140 are arranged in the third direction D3. The tab portions 140 are joined to one another, such as by ultrasonic bonding. Furthermore, as shown in FIG. 1, the tab portions 140 are joined to the first connecting member 40A, such as by ultrasonic bonding. Accordingly, the first external terminal 30A is electrically connected to the tab portions 140. Furthermore, the first external terminal 30A is electrically connected to the first conductive layer 120 and the second conductive layer 130. The configuration of each of the tab portions 140 and the configuration of each of the conductive auxiliary portions 150 will be described below.

As shown in FIG. 4, the tab portion 140 is connected to the first conductive layer 120 that is laminated on the third portion 113 of the support layer 110. Typically, the tab portion 140 is joined directly to the first conductive layer 120. The tab portion 140 is joined to the first conductive layer 120 by, for example, ultrasonic welding. The tab portion 140 extends in the first direction D1 above the first conductive layer 120. The tab portion 140 extends in a direction away from the first conductive layer 120. An extending direction DE in which the tab portion 140 extends is substantially parallel to the first direction D1. The tab portion 140 may be directly joined to the first external terminal 30A.

The conductive auxiliary portion 150 is connected to the second conductive layer 130 that is laminated on the third portion 113 of the support layer 110. Typically, the conductive auxiliary portion 150 is joined directly to the second conductive layer 130. The conductive auxiliary portion 150 is joined to the second conductive layer 130 by, for example, ultrasonic welding. An end of the conductive auxiliary portion 150 in the extending direction DE is joined to the tab portion 140 by ultrasonic welding.

The tab portion 140 and the conductive auxiliary portion 150 are made of a film material. The tab portion 140 and the conductive auxiliary portion 150 are typically made of a metal film including aluminum, copper, or the like.

The thickness of each of the tab portion 140 and the conductive auxiliary portion 150 is greater than the thickness of each of the first conductive layer 120 and the second conductive layer 130. The thickness of each of the tab portion 140 and the conductive auxiliary portion 150 is, for example, preferably 20 μm or less, more preferably 15 μm or less, and even more preferably 10 μm or less. The thickness of each of the tab portion 140 and the conductive auxiliary portion 150 is not particularly limited as long as it has a desired rigidity. The thickness of each of the tab portion 140 and the conductive auxiliary portion 150 may be, for example, 2 μm or more.

One of the first active material layers 200 A is laminated on the first conductive layer 120 that is laminated on the first portion 111. In the thickness direction DT, the first active material layer 200A on the first portion 111 is aligned with the first portion 111. An edge of the first active material layer 200A in the extending direction DE is aligned with an edge of the first portion 111 in the extending direction DE.

The other first active material layer 200A is laminated on the second conductive layer 130 that is laminated on the second portion 112. In the thickness direction DT, the first active material layer 200A on the second portion 112 is aligned with the second portion 112. An edge of the first active material layer 200A in the extending direction DE is aligned with an edge of the second portion 112 in the extending direction DE. These first active material layers 200A are cathode active material layers, but may also be anode active material layers. These first active material layers 200A are spaced apart from the tab portions 140 and the conductive auxiliary portions 150. The separators 12 are laminated on the first active material layers 200A in a radial direction centered on the winding axis Z.

The first protective portion 400 is made of an electrically insulating ceramic. The first protective portion 400 covers a part of the first active material layer 200A laminated on the first conductive layer 120 on an extending direction DE side. The first protective portion 400 covers the surface of the first conductive layer 120 between the first active material layer 200A and the tab portion 140. The first protective portion 400 is also partially disposed between the first conductive layer 120 and the tab portion 140.

The second protective portion 500 is made of an electrically insulating ceramic. The second protective portion 500 covers a part of the first active material layer 200A laminated on the second conductive layer 130 on the extending direction DE side. The second protective portion 500 covers the entire surface of the second conductive layer 130 between the first active material layer 200A and the conductive auxiliary portion 150. The second protective portion 500 is also partially disposed between the second conductive layer 130 and the conductive auxiliary portion 150.

As shown in FIG. 2, the second electrode 11B is laminated on the first active material layer 200A in the radial direction via the separators 12. In the embodiment, the electrode body 10 includes the multiple separators 12, but may include a single separator 12.

The second electrode 11B includes a second current collector 100B and a second active material layer 200B. The second current collector 100B is pulled out from between the second active material layers 200B to one side in the first direction D1. The second current collector 100B is joined to the second connecting member 40B by ultrasonic welding (see FIG. 1).

The second current collector 100B is made of, for example, a metal film. The second current collector 100B is made of, for example, a metal including copper. Accordingly, the second current collector 100B can be suitably used as an anode current collector. When the first current collector 100A is an anode current collector and the second current collector 100B is a cathode current collector, the second current collector 100B may be made of a metal including aluminum. The second current collector 100B may have the same structure as the first current collector 100A.

The second active material layers 200B are laminated on both sides of the second current collector 100B. In the embodiment, the second electrode 11B is an anode. Therefore, the second active material layer 200B is an anode active material layer. The second active material layer 200B may be a cathode active material layer.

As described above, the current collector 100A according to the embodiment of the present disclosure includes the support layer 110 and the first conductive layer 120. The first conductive layer 120 is made of a metal. The first conductive layer 120 is laminated on the support layer 110. The support layer 110 contains acid-modified polyethylene terephthalate.

According to the above configuration, the support layer 110 contains a PET resin, and thus has a relatively high rigidity. In addition, since the PET resin is an acid-modified PET, crystallization is suppressed. This allows fine cracks in the support layer 110 and bending of the support layer 110 to less likely to occur when the current collector 100A is bent. Furthermore, it is possible to suppress separation of the first conductive layer 120 from cracked or bent portions of the support layer 110.

In the embodiment, the support layer 110 also includes the first portion 111. The first conductive layer 120 is in contact with the first portion 111. The first portion 111 contains acid-modified polyethylene terephthalate.

According to the above configuration, in the first portion 111 that is in direct contact with the first conductive layer 120, fine cracks in the first portion 111 and bending of the first portion 111 is suppressed. Therefore, separation of the first conductive layer 120 from the first portion 111 can be suppressed.

In the embodiment, the current collector 100A further includes the second conductive layer 130. The second conductive layer 130 is made of a metal. The second conductive layer 130 is laminated on the support layer 110 on the opposite side of the support layer 110 from the first conductive layer 120. The support layer 110 further includes the second portion 112. The second conductive layer 130 is in contact with the second portion 112. The second portion 112 contains acid-modified polyethylene terephthalate.

According to the above configuration, even when the second conductive layer 130 is further provided on the support layer 110, fine cracks in the second portion 112 that is in direct contact with the second conductive layer 130 and bending of the second portion 112 is suppressed. Therefore, separation of the second conductive layer 130 from the second portion 112 can be suppressed.

In the embodiment, the support layer 110 further includes the third portion 113. The third portion 113 is located between the first portion 111 and the second portion 112. The third portion 113 contains polyethylene terephthalate. The third portion 113 does not contain acid-modified polyethylene terephthalate.

According to the above configuration, the third portion 113 is made of a material having a higher rigidity than the first portion 111 and the second portion 112. This makes it easy to design the rigidity of the support layer 110, for example, by adjusting the thicknesses of each of the first portion 111, the second portion 112, and the third portion 113.

In the above description of the embodiment, configurations that can be combined may be combined with each other.

The embodiment disclosed this time should be considered to be illustrative in all respects and not restrictive. The scope of the present disclosure is indicated by the claims rather than the description of the embodiment described above, and it is intended that all changes within the meaning and scope equivalent to the claims are included.

What is claimed is:

1. A current collector comprising:
a support layer; and
a first conductive layer, wherein
the first conductive layer is made of a metal,
the first conductive layer is laminated on the support layer, and
the support layer contains acid-modified polyethylene terephthalate.

2. The current collector according to claim 1, wherein:
the support layer includes a first portion;
the first conductive layer is in contact with the first portion; and
the first portion contains acid-modified polyethylene terephthalate.

3. The current collector according to claim 2, further comprising a second conductive layer, wherein:
the second conductive layer is made of a metal;
the second conductive layer is laminated on the support layer on an opposite side of the support layer from the first conductive layer;
the support layer further includes a second portion;
the second conductive layer is in contact with the second portion; and
the second portion contains acid-modified polyethylene terephthalate.

4. The current collector according to claim 3, wherein:
the support layer further includes a third portion;
the third portion is located between the first portion and the second portion; and
the third portion contains polyethylene terephthalate and does not contain acid-modified polyethylene terephthalate.

5. A battery comprising:
an electrode body; and
an external terminal, wherein
the electrode body includes a first electrode, a second electrode, and a separator,
the first electrode includes a current collector and an active material layer,
the current collector includes a support layer and a conductive layer,
the conductive layer is made of a metal,
the conductive layer is laminated on the support layer,
the support layer contains acid-modified polyethylene terephthalate,
the active material layer is laminated on the conductive layer,
the separator is laminated on the active material layer,
the second electrode is laminated on the active material layer via the separator, and
the external terminal is electrically connected to the conductive layer.
